(19) United States
(12) Patent Application Publication
(10) Pub. No.: US 2020/0239355 A1
(43) Pub. Date: Jul. 30, 2020

(54) GLASS COMPOSITION, NEUTRON-ABSORBING MATERIAL COMPRISING SAME, METHOD FOR MANAGING MOLTEN FUEL, METHOD FOR TAKING OUT MOLTEN FUEL, AND METHOD FOR STOPPING NUCLEAR REACTOR

(71) Applicant: HITACHI, LTD., Tokyo (JP)

(72) Inventors: Takashi NAITO, Tokyo (JP); Takuya AOYAGI, Tokyo (JP); Tatsuya MIYAKE, Tokyo (JP); Shin IMAMURA, Tokyo (JP); Hiroki KANEKO, Tokyo (JP)

(73) Assignee: HITACHI, LTD., Tokyo (JP)

(21) Appl. No.: 15/754,972

(22) PCT Filed: Aug. 5, 2016
(86) PCT No.: PCT/JP2016/073036

§ 371 Date: Feb. 23, 2018

(30) Foreign Application Priority Data
Sep. 3, 2015 (JP) 2015-173436

(51) Int. Cl. C03C 3/155; G21C 7/24; G21C 7/103; G21C 7/30

(52) U.S. Cl. CPC C03C 3/155; G21C 7/30; G21C 7/103; G21C 7/24

(57) ABSTRACT

The purpose of the present invention is to provide a neutron-absorbing material which has high neutron absorption performance, is less apt to suffer structural degradation caused by irradiation with neutrons or γ rays, and has satisfactory water resistance. The glass composition according to the present invention is characterized by containing Gd2O3, B2O3, CeO2, and Bi2O3 when the components are expressed in terms of oxide, the total amount of Gd2O3 and B2O3 being 65 mol % or greater in terms of oxide amount.

### TECHNICAL FIELD

The present invention relates to a glass composition, a neutron-absorbing material containing the glass composition, a method for managing molten fuel, a method for taking out molten fuel, and a method for stopping a nuclear reactor.

### BACKGROUND ART

In a nuclear power plant such as a boiling water type nuclear power plant or a pressurized water type nuclear power plant, a plurality of fuel assemblies including a nuclear fuel material (uranium pellet) is loaded in a core of a nuclear reactor. When the fuel assemblies are carried out in a normal operation cycle, since each of the fuel assemblies is designed so as to have a size preventing a single fuel assembly from reaching criticality, there is no risk to reach criticality if the fuel assemblies are carried out one by one, and the fuel assemblies can be carried out safely.

However, as in a nuclear power plant of Three Mile Nuclear Power Plant, in a case where an accident that a nuclear fuel material (uranium pellet) contained in a fuel assembly loaded in a core of a nuclear reactor melts occurs, there is a need for a method for preventing occurrence of criticality of this molten nuclear fuel material (hereinafter, referred to as “molten fuel”) and managing the molten fuel safely. The molten fuel is accumulated in a nuclear reactor pressure vessel or leaking into a containment vessel thereof. Furthermore, the molten fuel is obtained by melting of a uranium pellet in a fuel rod inside the nuclear reactor together with a surrounding structure. In addition, it is necessary to cut the molten fuel and carry out the molten fuel from the nuclear reactor. It is indispensable to prepare measures (taking out method) for preventing occurrence of criticality also in that case.

As one of techniques for preventing occurrence of criticality when molten fuel is managed or taken out, a method for injecting a neutron-absorbing material toward molten fuel disposed underwater has been considered. In this method, the neutron-absorbing material is brought into contact with a surface of molten fuel to absorb neutrons strongly released from the molten fuel, thereby preventing occurrence of criticality. In order to realize this method, a neutron-absorbing material needs to be able to be stably present underwater, to have a large absorption amount of neutrons generated from molten fuel, not to easily cause structural collapse by irradiation with or absorption of neutrons, and not to be easily eluted into water at the time of structural collapse. In addition, the neutron-absorbing material needs to be able to cope with diversification of shape and size such that the neutron-absorbing material can come into contact with molten fuel in various states. Furthermore, the neutron-absorbing material is discarded as high-level radioactive waste after use, and therefore ease of discard by vitrification or the like is also important. In that respect, it is effective to use a glass composition as the neutron-absorbing material.

PTL 1 (JP 2014-193794 A) discloses, as a neutron-absorbing material containing water-resistant glass, a neutron-absorbing glass containing B₂O₃, Gd₂O₃, and SiO₂, characterized in that the total content of B₂O₃ and Gd₂O₃ is 50 to 80% by weight, and the content of B₂O₃ is equal to or more than the content of Gd₂O₃ and equal to or more than the content of SiO₂ on the basis of weight.

PTL 2 (JP 2009-7194 A) proposes not a neutron-absorbing material as described above, but as a transparent window glass capable of shielding radiation such as an X ray or a γ ray, a glass composition containing SiO₂, B₂O₃, Gd₂O₃, La₂O₃, Al₂O₃, ZnO, BaO, ZrO₂, WO₃, CeO₂, and the like. Furthermore, Examples of PTL 2 specifically disclose a glass composition having such a composition that the content of SiO₂ is 18 to 30 mol %, the content of B₂O₃ is 18 to 38 mol %, the content of Al₂O₃ is 2.8 to 19.8 mol %, the content of ZnO is 0 to 9 mol %, the content of BaO is 0 to 1.5 mol %, the content of K₂O is 0 to 1.0%, the content of Na₂O is 0 to 0.5%, the content of ZrO₂ is 0 to 6.5 mol %, the content of La₂O₃ is 0 to 13 mol %, the content of Gd₂O₃ is 0 to 20 mol %, the content of WO₃ is 0 to 5 mol %, the content of CeO₂ is 0 to 0.05 mol %, and the content of Sb₂O₃ is 0.1 to 0.2 mol %.

PTL 3 (JP 2014-55092 A) proposes not a neutron-absorbing material as described above, but as a medical vessel transparent glass hardly colored by irradiation with radiation such as a γ ray or an electron beam, that is, hardly causing structural collapse, a glass composition containing SiO₂, B₂O₃, Na₂O, K₂O, BaO, ZnO, CeO₂, and the like. Examples of PTL 3 specifically disclose a glass composition having such a composition that the content of SiO₂ is 63 to 69% by mass, the content of Al₂O₃ is 0 to 2.5% by mass, the content of B₂O₃ is 2.5 to 5% by mass, the content of Li₂O is 0 to 4% by mass, the content of Na₂O is 6 to 9.5% by mass, the content of K₂O is 6.1 to 8.1% by mass, the content of BaO is 10 to 13% by mass, the content of ZnO is 0.2 to 2% by mass, the content of CeO₂ is 1.1 to 2% by mass, the content of SnO₂ is 0 to 0.5% by mass, the content of Fe₂O₃ is 0.01 to 0.02% by mass, the content of TiO₂ is 0.01 to 0.04% by mass, and the content of ZrO₂ is 0.03 to 0.1% by mass.

### CITATION LIST

### Patent Literature

PTL 1: JP 2014-193794 A

PTL 2: JP 2009-7194 A

PTL 3: JP 2014-55092 A

### SUMMARY OF INVENTION

### Technical Problem

The neutron-absorbing glass disclosed in PTL 1 has neutron-absorbing ability and water resistance. However, no means for suppressing structural collapse due to neutron absorption has been studied at all.

In the glass composition described in PTL 2, detergent resistance and acid resistance are improved, and even if cleaning or the like is performed, scorch does not occur. This glass composition contains gadolinium (Gd) or boron (B) having a large neutron-absorbing cross section, and therefore has neutron-absorbing performance. However, in order to efficiently prevent occurrence of criticality of molten fuel, a glass composition needs to contain more Gd₂O₃ or B₂O₃ (in Examples of PTL 2, the total content of Gd₂O₃ and B₂O₃ is 53.5 mol % at maximum).

In addition, in the glass composition described in PTL 2, continuous and long-term irradiation with strong neutrons or γ rays underwater is not considered, and it is considered that a glass structure will be easily collapsed by the irradiation. Furthermore, it is feared that a glass component is easily eluted underwater due to the structural collapse.

The glass composition described in PTL 3 is characterized in that the glass composition is hardly colored even by irradiation with neutrons or γ rays due to inclusion of an appropriate amount of CeO₂. That is, as compared with the glass composition described in PTL 2 and the like, it is expected that collapse of a glass structure due to irradiation with neutrons or γ rays is reduced and elution of a glass component underwater is also reduced.

However, even in the glass composition described in PTL 3, continuous and long-term irradiation with strong neutrons or γ rays underwater is not supposed. In addition, this glass composition contains only a small amount of element absorbing neutrons or γ rays, and therefore has a big problem that neutron-absorbing performance is extremely low.

As described above, the glass compositions described in PTLs 1 to 3 do not have sufficient performance as a neutron-absorbing material for preventing occurrence of criticality of molten fuel underwater.

In view of the above circumstances, an object of the present invention is to provide a neutron-absorbing material having high neutron-absorbing performance and hardly causing structural collapse by irradiation with neutrons or γ rays.

### Solution to Problem

In order to achieve the above object, the present invention is characterized in that a glass composition according to the present invention contains Gd₂O₃, B₂O₃, CeO₂, and Bi₂O₃ when components are expressed as oxides and that the total content of Gd₂O₃ and B₂O₃ is 65 mol % or more in terms of oxide.

### Advantageous Effects of Invention

According to the glass composition of the present invention, it is possible to provide a neutron-absorbing material having high neutron-absorbing performance and hardly causing structural collapse by irradiation with neutrons or γ rays.

### BRIEF DESCRIPTION OF DRAWINGS

FIG. 1A is a perspective view schematically illustrating an example of a spherical neutron-absorbing material composed of a glass composition.

FIG. 1B is a perspective view schematically illustrating an example of a tablet-shaped neutron-absorbing material composed of a glass composition.

FIG. 1C is a perspective view schematically illustrating an example of a granular neutron-absorbing material composed of a glass composition.

FIG. 1D is a perspective view schematically illustrating an example of a bead-shaped neutron-absorbing material composed of a glass composition.

FIG. 2 is a perspective view schematically illustrating an example of a neutron-absorbing material containing a glass composition.

FIG. 3 is a perspective view schematically illustrating another example of a neutron-absorbing material containing a glass composition.

FIG. 4 is a cross-sectional view schematically illustrating a part of the vicinity of a surface of molten fuel.

FIG. 5 is a cross-sectional view schematically illustrating a part of the vicinity of a surface of molten fuel in operation of taking out the molten fuel.

FIG. 6 is a representative curve obtained by DTA measurement of a glass composition.

FIG. 7 is an emission spectrum of a glass composition according to Example 2.

FIG. 8 is an emission spectrum of a glass composition according to Example 2.

FIG. 9 is a cross-sectional view schematically illustrating an example of a manufacturing apparatus for manufacturing a neutron-absorbing material composed of a glass composition.

FIG. 10 is a cross-sectional view schematically illustrating another example of a manufacturing apparatus for manufacturing a neutron-absorbing material composed of a glass composition.

FIG. 11 is a cross-sectional view schematically illustrating an example of a manufacturing apparatus for manufacturing a neutron-absorbing material containing a glass composition.

### DESCRIPTION OF EMBODIMENTS

Conventionally, it is known that boron is used as a neutron-absorbing material used in nuclear reactor facilities. However, in a case where boron is injected toward underwater molten fuel, boric acid generated by a reaction between boron and water may corrode piping. Therefore, the present inventors have decided to use, as a neutron-absorbing material, a glass composition which can be stably present underwater, can be easily processed, can be molded into various shapes and sizes, and is easily vitrified for discard thereof after use. The present inventors have made intensive studies on a glass composition having high neutron-absorbing performance and hardly causing structural collapse by irradiation with neutrons or γ rays. As a result, the present inventors have found that a glass composition containing Gd₂O₃ and B₂O₃ having high neutron-absorbing performance, CeO₂ having radiation resistance (neutron resistance and γ ray resistance) and capable of suppressing structural collapse of glass, and Bi₂O₃ capable of improving water resistance satisfies the above performance sufficiently. The present invention is based on this knowledge.

Hereinafter, an embodiment of the present invention will be described. However, the present invention is not limited to the embodiment, and various improvements or modifications can be made within a range not changing the gist of the present invention.

[Glass Composition]

As described above, the glass composition according to the present invention contains gadolinium oxide (Gd₂O₃), boron oxide (B₂O₃), cerium oxide (CeO₂), and bismuth oxide (Bi₂O₃) when components are expressed as oxides, and the total content of Gd₂O₃ and B₂O₃ is 65 mol % or more in terms of oxide. By adopting such a configuration, it is possible to provide a glass composition having high neutron-absorbing performance, hardly causing structural collapse by irradiation with neutrons or γ rays, and also having excellent water resistance. This glass composition can be present stably underwater, and therefore can be effectively developed as a neutron-absorbing material which can be injected toward underwater molten fuel.

By setting the total content of Gd₂O₃ and B₂O₃ to 65 mol % or more, excellent neutron-absorbing performance can be obtained. However, in consideration of water resistance, the total content of Gd₂O₃ and B₂O₃ is desirably 88 mol % or less. Furthermore, the total content of Gd₂O₃, B₂O₃, CeO₂, and Bi₂O₃ is preferably 72 to 92 mol %. By setting the total content of Gd₂O₃, B₂O₃, CeO₂, and Bi₂O₃ to 72 to 92 mol %, it is possible to reduce collapse of a glass structure by irradiation with neutrons or γ rays and to obtain good water resistance. Furthermore, the content of CeO₂ is effectively 1 mol % or more and the content of Bi₂O₃ is effectively 2 mol % or more. In addition, a residue effectively contains at least one of barium oxide (BaO), strontium oxide (SrO), zinc oxide (ZnO), lanthanum oxide (La₂O₃), yttrium oxide (Y₂O₃), aluminum oxide (Al₂O₃), and zirconium oxide (ZrO₂) in order to accelerate vitrification and to improve water resistance.

The glass composition may contain at least one of Eu₂O₃, Er₂O₃, Tb₂O₃, Pr₂O₃, Nd₂O₃, Sm₂O₃, Dy₂O₃, Ho₂O₃, Tm₂O₃, and Yb₂O₃. By inclusion of these components, a glass composition that emits light by irradiation with neutrons can be obtained. By use of this glass composition as a neutron-absorbing material, critical proximity can be detected by intensity or wavelength of emitted light. The total content of Eu₂O₃, Er₂O₃, Tb₂O₃, Pr₂O₃, Nd₂O₃, Sm₂O₃, Dy₂O₃, Ho₂O₃, Tm₂O₃, and Yb₂O₃ is preferably 0.1 mol % or more and 2.0 mol % or less.

Table 1 indicates a neutron-absorbing cross section of each element. Elements with a large neutron-absorbing cross section are extracted and indicated in Table 1. Generally, as an element has a larger neutron-absorbing cross section, neutron-absorbing performance tends to be higher although depending on an energy state of emitted neutrons. Gadolinium (Gd) element contained in the neutron-absorbing glass of the present invention has the largest neutron-absorbing cross section, but Gd element is expensive. Meanwhile, boron (B) element has a neutron-absorbing cross section not larger than Gd element, but can absorb neutrons in a wide energy state and is inexpensive. The glass composition of the present invention absorbs neutrons due to inclusion of Gd element in Gd₂O₃ and B element in B₂O₃. Furthermore, B₂O₃ containing B element is also an indispensable element for vitrification.

TABLE 1

| | | Neutron-absorbing |
|---|---|---|
| | Atomic | cross section |
| Element | number | (barn) |
| Li | 3 | 71 |
| B | 5 | 759 |
| Rh | 45 | 155 |
| Cd | 48 | 2450 |
| In | 49 | 194 |
| Sm | 62 | 5800 |
| Eu | 63 | 4300 |
| Gd | 64 | 46000 |
| Dy | 66 | 940 |
| Er | 68 | 160 |
| Tm | 69 | 125 |
| Hf | 72 | 105 |
| Hg | 80 | 360 |

In addition, in the glass composition of the present invention, inclusion of CeO₂ can reduce collapse of a glass structure by irradiation with neutrons or γ rays. According to this principle, it is considered that a portion where a bond of a glass structure is cut by irradiation with neutrons or γ rays is self-repaired by change in valence of a Ce ion in the glass. Therefore, the larger number of Ce ions in the glass exhibits radiation resistance more effectively. However, solubility of CeO₂ in glass is low, and usually, it is not easy to increase the content of CeO₂ and to cause vitrification. Generally, as the content of CeO₂ in glass increases, the glass becomes more colored and has lower transparency. Therefore, it is impossible to suppose increasing the content of CeO₂ in glass in which securing transparency is one of objects as in PTLs 2 and 3.

As described above, B₂O₃ is an indispensable vitrifying component for generating a glass state. However, even if the content of B₂O₃ is increased, if a binary glass composition of Gd₂O₃ and B₂O₃ contains CeO₂ capable of reducing collapse of a glass structure by irradiation with neutrons or γ rays, crystallization or phase separation occurs, a uniform and homogeneous glass composition cannot be obtained, and only a small amount of CeO₂ can be contained disadvantageously. In addition, the binary glass composition of Gd₂O₃ and B₂O₃ has poor water resistance disadvantageously. Inclusion of Bi₂O₃ has solved these problems simultaneously. The present inventors have found that a Gd₂O₃—B₂O₃—CeO₂—Bi₂O₃ glass composition has high neutron-absorbing performance, can suppress or prevent collapse of a glass structure by irradiation with neutrons or γ rays, and can improve water resistance.

As preferable composition ranges of components of the glass composition of the present invention, in terms of oxide as described below, the content of Gd₂O₃ is 5 to 15 mol %, the content of B₂O₃ is 55 to 75 mol %, the content of CeO₂ is 1 to 10 mol %, the content of Bi₂O is 2 to 15 mol %, and the total content of one or more of BaO, SrO, ZnO, La₂O₃, Y₂O₃, Al₂O₃, and ZrO₂ is 8 to 28 mol %. As particularly effective composition ranges, in terms of oxide as described below, the content of Gd₂O₃ is 5 to 10 mol %, the content of B₂O₃ is 60 to 70 mol %, the content of CeO₂ is 3 to 10 mol %, the content of Bi₂O₃ is 2 to 10 mol %, and the total content of one or more of BaO, SrO, ZnO, La₂O₃, Y₂O₃, Al₂O₃, and ZrO₂ is 10 to 23 mol %. Incidentally, here, in a case where “x to y mol %” is described for an oxide, this means that “x mol % or more and y mol % or less”.

Furthermore, the glass composition of the present invention has a specific gravity of about “4 to 5”, which is significantly larger than that of water or seawater. Therefore, even if the glass composition is injected underwater, the glass composition can go down stably. Furthermore, by setting a proper shape and size, the glass composition can be in contact with underwater molten fuel without fluttering underwater due to water circulation.

As described above, the glass composition of the present invention can be effectively developed as a neutron-absorbing material.

[Neutron-Absorbing Material]

Next, a neutron-absorbing material containing the glass composition of the present invention will be described. The neutron-absorbing material according to the present invention is composed of the glass composition of the present invention or contains the glass composition of the present invention.

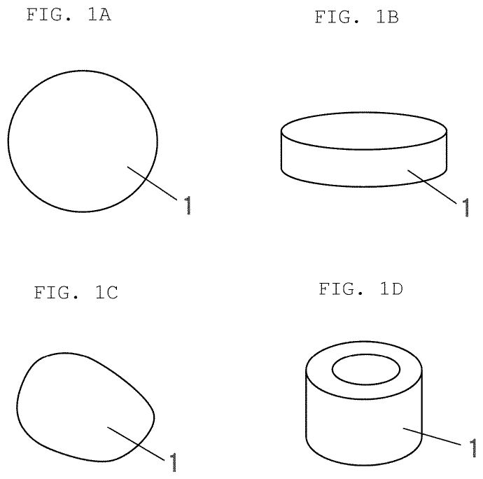

The form and size of the neutron-absorbing material composed of the glass composition of the present invention will be described with reference to FIGS. 1A to 1D. FIG. 1A is a perspective view schematically illustrating an example of a spherical neutron-absorbing material, and FIG. 1B is a perspective view schematically illustrating an example of a tablet-shaped neutron-absorbing material. FIG. 1C is a perspective view schematically illustrating an example of a granular neutron-absorbing material, and FIG. 1D is a perspective view schematically illustrating an example of a bead-shaped neutron-absorbing material. A neutron-absorbing material 1 illustrated in FIGS. 1A to 1D is composed of a glass composition 2. The glass composition 2 is a material having good thermal moldability unlike a ceramic or the like, and therefore the shape of the neutron-absorbing material 1 illustrated in the above FIGS. 1A to 1D can be manufactured at low cost. An optimum shape is preferably selected from these shapes according to a situation of injection into molten fuel.

A proper average size of the neutron-absorbing material 1 composed of the glass composition 2 of the present invention is desirably 0.1 mm mesh or more and less than 15 mm mesh. If the size is less than 0.1 mm mesh, the neutron-absorbing material 1 may flutter underwater due to a water flow because the size is too small. Meanwhile, if the size is 15 mm mesh or more, there is a possibility that the neutron-absorbing material 1 will not spread over molten fuel because the neutron-absorbing material 1 is caught on the way at the time of injection or hardly comes into contact with the molten fuel. A more preferable average size is 1 mm mesh or more and less than 10 mm mesh. Note that “mesh” is a unit based on Japanese Industrial Standards (JIS standard).

The neutron-absorbing material according to the present invention may be a mixture of a plurality of glass compositions having different sizes. For example, a first glass composition having a size of 0.1 mm mesh or more and less than 5 mm mesh and a second glass composition having a size of 5 mm mesh or more and less than 15 mm mesh may be mixed. A glass composition having a small size enters a gap between pieces of molten fuel to stop criticality. A glass composition having a large size suppresses fluttering of debris and a small glass composition.

A method for manufacturing a neutron-absorbing material having the above shape and size will be described in detail in Examples described below.

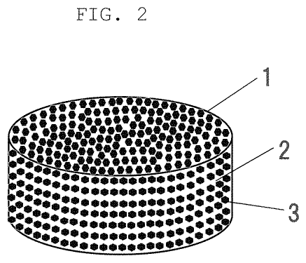

The neutron-absorbing material according to the present invention may contain boron carbide (B₄C) particles. FIG. 2 is a perspective view schematically illustrating an example of a neutron-absorbing material containing a glass composition. As illustrated in FIG. 2, the neutron-absorbing material 1 according to the present invention is obtained by sintering boron carbide (B₄C) particles 3 containing a B element having high neutron-absorbing performance in a large amount with the above glass composition 2.

B₄C is one of generally known neutron-absorbing materials, and is widely used as a neutron-shielding material or a nuclear reaction controlling material in a nuclear reactor. For example, in a boiling water type nuclear reactor, a control rod packed with B₄C is used for controlling a nuclear fission reaction in a nuclear reactor during normal operation and an emergency. However, a single substance of B₄C is hardly sintered, a B element is eluted underwater due to surface oxidation or the like, and an acidic corrosive environment may be generated. By combining such B₄C with the glass composition of the present invention, a desired shape and size can be easily obtained, and good water resistance can be obtained. Furthermore, it is possible to obtain higher neutron-absorbing performance than in a case where the glass composition according to the present invention is used singly. However, the number of steps in manufacturing this neutron-absorbing material is large, and cost may be higher than in a case where the glass composition of the present invention is used singly.

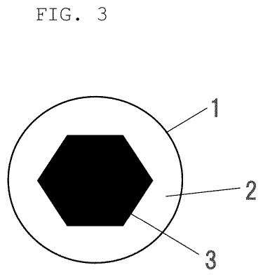

FIG. 3 is a perspective view schematically illustrating another example of a neutron-absorbing material containing the glass composition of the present invention. In the form of FIG. 3, in the neutron-absorbing material 1, surfaces of granular B₄C particles 3 are coated with the glass composition 2. In the form illustrated in FIG. 2, the number of steps in manufacturing the neutron-absorbing material 1 is large in order to sinter the glass composition 2 and the B₄C particles 3. However, in the present embodiment, the number of steps can be reduced, and the neutron-absorbing material 1 can be manufactured more easily than the above sintered body. A method for manufacturing the above neutron-absorbing material will be described in detail in Examples described below.

[Method for Managing Molten Fuel, Method for Taking Out Molten Fuel, and Method for Stopping Nuclear Reactor]

Next, a method for managing molten fuel, a method for taking out molten fuel, and a method for stopping a nuclear reactor according to the present invention will be described.

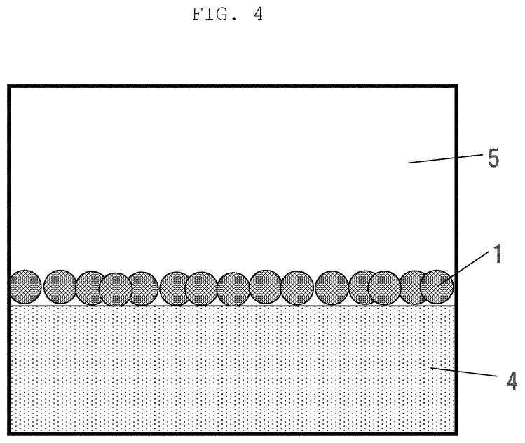

FIG. 4 is a cross-sectional view schematically illustrating a part of the vicinity of a surface of molten fuel. FIG. 4 illustrates a state where the neutron-absorbing material 1 is in contact with a surface of molten fuel 4 accumulated in a nuclear reactor pressure vessel or leaking out of a containment vessel. The neutron-absorbing material 1 is injected underwater 5 from above the molten fuel 4 managed underwater 5. By contact of the neutron-absorbing material 1 with the molten fuel 4 or presence thereof in the vicinity of the molten fuel 4, the neutron-absorbing material 1 absorbs neutrons emitted from the molten fuel 4, and a subcritical state of the molten fuel 4 can be maintained.

In order to allow the neutron-absorbing material 1 according to the present invention to be injected toward the molten fuel 4 in this way at any time, it is desirable to prepare the neutron-absorbing material 1 according to the present invention on a side of the nuclear reactor pressure vessel or a containment vessel all the time.

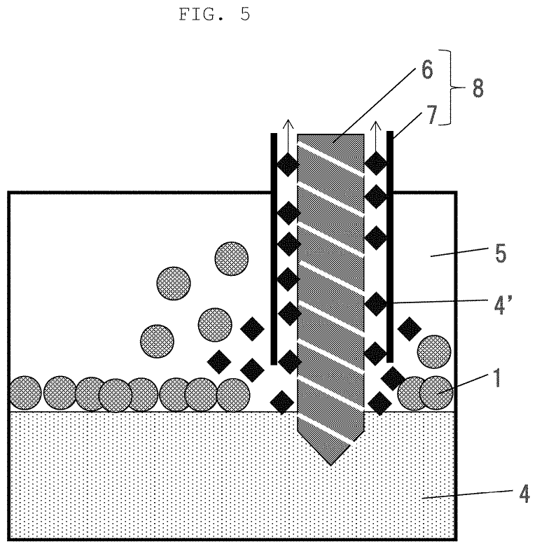

FIG. 5 is a cross-sectional view schematically illustrating a part of the vicinity of a surface of molten fuel in operation of taking out the molten fuel. As illustrated in FIG. 5, in the method for taking out the molten fuel 4 according to the present invention, the molten fuel 4 is excavated from the state of FIG. 4 (state where the neutron-absorbing material 1 is in contact with a surface of the molten fuel 4). A fragment of the molten fuel 4 (molten fuel 4′) flutters in the water 5 by excavation, but the neutron-absorbing material 1 also flutters together with the molten fuel 4′. Re-criticality can be thereby prevented, and the molten fuel 4′ can be safely taken out of a nuclear reactor. In addition, by use of an excavator 8 having a suction pipe 7 around a drill 6, the excavated molten fuel 4′ can be sucked while being cut. Therefore, the amount of scattering of the molten fuel 4′ to surroundings decreases, and the molten fuel 4′ can be more safely taken out of the nuclear reactor.

The method for stopping a nuclear reactor according to the present invention is a method for stopping a nuclear reactor in an emergency. By injecting the neutron-absorbing material according to the present invention into a nuclear reactor, and making the neutron-absorbing material deposited around a fuel rod in the nuclear reactor, it is possible to prevent molten fuel from reaching criticality and to stop the nuclear reactor. It is very important to prepare a neutron-absorbing material for each nuclear reactor all the time together with equipment that makes injection possible at any time in order to be able to inject the neutron-absorbing material immediately into the nuclear reactor in an emergency.

### EXAMPLES

Hereinafter, the present invention will be described in more detail by way of Examples. However, the present invention is not limited to Examples described here.

### Example 1

[Manufacture of Glass Composition]

In the present Example 1, glass compositions having various compositions were manufactured, and characteristics thereof were evaluated. For manufacturing glass, reagents (Gd₂O₃, B₂O₃, CeO₂, Bi₂O₃, BaCO₃, SrCO₃, ZnO, La₂O₃, Y₂O₃, Al₂O₃, ZrO₂, SiO₂, Li₂CO₃, Na₂CO₃, and K₂CO₃) manufactured by Kojundo Chemical Laboratory Co. Ltd. were used as raw materials. Table 2 indicates compositions in glass compositions of Examples (glass Nos. GA-01 to GA-30). Table 3 indicates compositions of glass compositions in Comparative Examples (glass Nos. GB-01 to GB-44).

TABLE 2

| | Composition (mol %) | | | | | | | | | | | | |
|---|---|---|---|---|---|---|---|---|---|---|---|---|---|
| | | | | | | | | | | | | | R₂O |
| Glass No. | Gd₂O₃ | B₂O₃ | CeO₂ | Bl₂O₃ | BaO | SrO | ZnO | La₂O₃ | Y₂O₃ | Al₂O₃ | ZrO₂ | SiO₂ | (R: Alkali metal) |
| GA-01 | 5.0 | 60.0 | 1.0 | 15.0 | 9.0 | — | — | 4.0 | 2.0 | 2.0 | 2.0 | — | — |
| GA-02 | 5.0 | 65.0 | 3.0 | 10.0 | 10.0 | 2.0 | — | 5.0 | — | — | — | — | — |
| GA-03 | 5.0 | 70.0 | 5.0 | 5.0 | — | 8.0 | 2.0 | 5.0 | — | — | — | — | — |
| GA-04 | 5.5 | 75.0 | 8.0 | 4.5 | 5.0 | — | 2.0 | — | — | — | — | — | — |
| GA-05 | 6.0 | 60.0 | 2.0 | 4.0 | 9.0 | 2.0 | 10.0 | 5.0 | 1.0 | 1.0 | — | — | — |
| GA-06 | 6.0 | 63.0 | 6.0 | 2.0 | 8.0 | 3.0 | 5.0 | 3.0 | 2.0 | 1.0 | 1.0 | — | — |
| GA-07 | 6.5 | 60.1 | 7.0 | 3.9 | 7.8 | — | 14.7 | — | — | — | — | — | — |
| GA-08 | 6.7 | 61.5 | 3.5 | 5.3 | 8.0 | — | 15.0 | — | — | — | — | — | — |
| GA-09 | 6.9 | 63.3 | 7.3 | 2.7 | 8.2 | — | 7.7 | 3.9 | — | — | — | — | — |
| GA-10 | 7.0 | 63.9 | 7.5 | 5.5 | 8.3 | — | 7.8 | — | — | — | — | — | — |
| GA-11 | 7.0 | 68.0 | 8.0 | 4.0 | — | 9.0 | — | 3.0 | — | 1.0 | — | — | — |
| GA-12 | 7.1 | 64.8 | 3.7 | 4.1 | 8.4 | — | 7.9 | 4.0 | — | — | — | — | — |
| GA-13 | 7.3 | 67.3 | 3.9 | 7.8 | 8.7 | — | 5.0 | — | — | — | — | — | — |
| GA-14 | 7.4 | 67.6 | 8.0 | 4.1 | 8.8 | — | — | 4.1 | — | — | — | — | — |
| GA-15 | 7.5 | 68.9 | 4.0 | 4.4 | 8.9 | — | — | 6.3 | — | — | — | — | — |
| GA-16 | 7.6 | 70.2 | 4.1 | 9.0 | 9.1 | — | — | — | — | — | — | — | — |
| GA-17 | 8.0 | 65.0 | 5.0 | 5.0 | 8.0 | — | 4.5 | 4.5 | — | — | — | — | — |
| GA-18 | 8.0 | 75.0 | 3.0 | 6.0 | 5.0 | — | 3.0 | — | — | — | — | — | — |
| GA-19 | 8.5 | 61.0 | 10.0 | 5.5 | 10.0 | — | — | 5.0 | — | — | — | — | — |
| GA-20 | 9.0 | 65.0 | 6.5 | 10.0 | 7.5 | — | — | 2.0 | — | — | — | — | — |
| GA-21 | 9.0 | 66.0 | 1.0 | 9.0 | 5.0 | — | 5.0 | 5.0 | — | — | — | — | — |
| GA-22 | 9.5 | 69.0 | 4.5 | 5.5 | 8.0 | — | — | 3.5 | — | — | — | — | — |
| GA-23 | 10.0 | 60.0 | 8.0 | 8.0 | 8.0 | — | 3.0 | 3.0 | — | — | — | — | — |
| GA-24 | 10.0 | 63.5 | 1.5 | 5.5 | 7.0 | — | 10.0 | 2.5 | — | — | — | — | — |
| GA-25 | 10.0 | 70.0 | 5.0 | 5.0 | 7.0 | — | — | 3.0 | — | — | — | — | — |
| GA-26 | 10.2 | 71.4 | 3.6 | 2.6 | 12.2 | — | — | — | — | — | — | — | — |
| GA-27 | 11.2 | 68.6 | 4.0 | 7.3 | 8.9 | — | — | — | — | — | — | — | — |
| GA-28 | 12.0 | 73.0 | 4.5 | 2.5 | 5.0 | — | 2.0 | 1.0 | — | — | — | — | — |
| GA-29 | 13.0 | 55.0 | 2.0 | 10.0 | 10.0 | — | 10.0 | — | — | — | — | — | — |
| GA-30 | 15.0 | 73.0 | 2.0 | 2.0 | 6.0 | — | — | 2.0 | — | — | — | — | — |

TABLE 3

| | Composition (mol %) | | | | | | | | | | | | |
|---|---|---|---|---|---|---|---|---|---|---|---|---|---|
| | | | | | | | | | | | | | R₂O |
| Glass No. | Gd₂O₃ | B₂O₃ | CeO₂ | Bi₂O₃ | BaO | SrO | ZnO | La₂O₃ | Y₂O₃ | Al₂O₃ | ZrO₂ | SiO₂ | (R: Alkali metal) |
| GB-01 | — | 25.0 | — | — | — | — | — | — | — | 4.0 | — | 65.0 | Li₂O: 2.0, Na₂O: 2.0, K₂O: 2.0 |
| GB-02 | — | 25.0 | 3.0 | — | — | — | — | — | — | 4.0 | — | 62.0 | Li₂O: 2.0, Na₂O: 2.0, K₂O: 2.0 |
| GB-03 | — | 40.0 | — | — | — | — | 50.0 | — | — | — | — | 10.0 | — |
| GB-04 | — | 40.0 | 0.5 | — | — | — | 49.5 | — | — | — | — | 10.0 | — |
| GB-05 | 5.0 | 65.0 | 0.5 | — | — | — | 25.0 | — | — | — | — | — | Li₂O: 2.5, Na₂O: 2.0 |
| GB-06 | 6.0 | 48.0 | 0.5 | — | — | — | — | — | — | — | 3.0 | 28.0 | Li₂O: 8.0, Na₂O: 6.5 |
| GB-07 | 6.1 | 47.8 | — | — | — | — | — | — | — | — | 3.4 | 27.7 | Li₂O: 8.3, Na₂O: 6.7 |
| GB-08 | 6.4 | 49.5 | — | — | — | — | — | — | — | — | 7.0 | 21.5 | Li₂O: 8.6, Na₂O: 7.0 |
| GB-09 | 6.5 | 50.0 | 1.0 | — | — | — | — | — | — | — | 7.0 | 21.5 | Li₂O: 7.0, Na₂O: 7.0 |
| GB-10 | 6.5 | 70.0 | 3.0 | — | 3.0 | 3.0 | 14.5 | — | — | — | — | — | — |
| GB-11 | 6.7 | 56.4 | 2.8 | — | 9.6 | — | — | — | — | — | — | 24.5 | — |
| GB-12 | 6.9 | 53.5 | — | — | — | — | 20.5 | — | — | 4.6 | 3.8 | — | Li₂O: 6.2, Na₂O: 4.5 |
| GB-13 | 7.0 | 53.5 | 0.5 | — | — | — | 21.0 | — | — | 4.5 | 3.5 | — | Li₂O: 6.0, Na₂O: 4.0 |
| GB-14 | 7.0 | 68.0 | 1.0 | — | 4.0 | 4.0 | 16.0 | — | — | — | — | — | — |
| GB-15 | 7.6 | 60.0 | — | — | — | — | 17.1 | — | — | 4.6 | — | — | Li₂O: 6.2, Na₂O: 4.5 |
| GB-16 | 7.7 | 60.7 | — | — | — | — | 11.5 | — | — | 9.3 | — | — | Li₂O: 6.3, Na₂O: 4.5 |
| GB-17 | 7.8 | 61.4 | — | — | — | — | 5.8 | — | — | 14.0 | — | — | Li₂O: 6.4, Na₂O: 4.6 |
| GB-18 | 8.0 | 65.0 | — | — | 3.0 | 3.0 | 18.0 | — | — | 3.0 | — | — | — |
| GB-19 | 8.0 | 52.5 | 0.5 | — | — | — | 15.0 | — | — | 15.0 | — | — | Li₂O: 4.0, Na₂O: 3.0, K₂O: 2.0 |
| GB-20 | 8.0 | 64.5 | 3.0 | — | — | — | 24.5 | — | — | — | — | — | — |
| GB-21 | 8.0 | 66.0 | 3.0 | — | 2.0 | 2.0 | 19.0 | — | — | — | — | — | — |
| GB-22 | 8.5 | 71.5 | 0.5 | — | 3.0 | 3.0 | 13.5 | — | — | — | — | — | — |
| GB-23 | 8.5 | 66.5 | 6.0 | — | — | — | 19.0 | — | — | — | — | — | — |
| GB-24 | 9.0 | 55.0 | 2.0 | — | — | — | — | — | — | — | 4.0 | 17.0 | Li₂O: 5.0, Na₂O: 5.0, K₂O: 3.0 |
| GB-25 | 10.0 | 60.0 | — | — | — | — | 30.0 | — | — | — | — | — | — |
| GB-26 | 10.0 | 50.0 | — | — | — | — | 30.0 | — | — | 10.0 | — | — | — |
| GB-27 | 10.0 | 50.0 | 0.5 | — | — | — | 30.0 | — | — | 10.0 | — | — | — |
| GB-28 | 10.0 | 50.0 | — | — | — | — | 30.0 | — | — | — | — | — | Li₂O: 5.0, Na₂O: 5.0 |
| GB-29 | 10.0 | 50.0 | 0.5 | — | — | — | 30.0 | — | — | — | — | — | Li₂O: 5.0, Na₂O: 4.5 |
| GB-30 | 10.0 | 40.0 | — | — | — | — | — | — | — | — | 5.0 | 35.0 | Li₂O: 5.0, Na₂O: 5.0 |
| GB-31 | 10.0 | 40.0 | 1.0 | — | — | — | — | — | — | — | 5.0 | 35.0 | Li₂O: 5.0, Na₂O: 4.0 |
| GB-32 | 12.0 | 45.0 | 3.0 | — | — | — | — | — | — | — | 7.0 | 25.0 | Li₂O: 4.0, Na₂O: 4.0 |
| GB-33 | 13.0 | 42.0 | — | — | — | — | 45.0 | — | — | — | — | — | — |
| GB-34 | 13.0 | 42.0 | 1.0 | — | — | — | 44.0 | — | — | — | — | — | — |
| GB-35 | 13.9 | 65.1 | 1.7 | — | — | — | — | 7.7 | — | — | — | — | Li₂O: 6.8, Na₂O: 4.8 |
| GB-36 | 15.9 | 55.8 | 2.3 | — | 7.6 | — | 8.0 | 2.0 | 2.0 | — | — | — | Li₂O: 3.2, Na₂O: 3.2 |
| GB-37 | 16.0 | 56.7 | 2.3 | — | 7.0 | — | — | 2.0 | 2.0 | 6.0 | — | — | Li₂O: 4.0, Na₂O: 4.0 |
| GB-38 | 17.8 | 41.0 | 3.7 | — | 8.5 | — | 16.0 | — | — | — | — | — | Li₂O: 13.0 |
| GB-39 | 18.3 | 53.3 | 4.3 | — | 24.1 | — | — | — | — | — | — | — | — |
| GB-40 | 20.0 | 26.0 | 0.5 | — | — | — | 10.0 | — | — | 10.0 | 3.5 | 30.0 | — |
| GB-41 | 21.7 | 45.5 | 2.8 | — | — | — | 9.0 | 9.0 | 2.0 | — | — | — | Li₂O: 10.0 |
| GB-42 | 23.5 | 49.3 | 3.0 | — | — | — | — | 13.1 | — | — | — | — | Li₂O: 11.1 |
| GB-43 | 31.3 | 41.0 | 3.3 | — | — | — | — | 11.7 | — | — | — | — | Li₂O: 12.7 |
| GB-44 | 44.2 | 31.0 | 3.8 | — | — | — | — | 6.6 | — | — | — | — | Li₂O: 14.4 |

[Evaluation of Characteristics of Glass Composition]

Hereinafter, a method for evaluating a glass manufacturing property (ease of manufacturing), a characteristic temperature (transition point T_{g}), water resistance, irradiation resistance with respect to radiation (γ rays), and water resistance after irradiation as evaluation items of a glass composition will be described. Note that gamma (γ) rays were used in place of neutrons for an irradiation resistance test of radiation.

(1) Evaluation of Glass Manufacturing Property (Evaluation of Uniformity and Homogeneity)

A manufacturing property of a glass composition was evaluated in a state of glass melted at 1300 to 1350° C. For the glass composition, 250 to 300 g of the above glass raw materials blended and mixed in predetermined amounts were put in a platinum crucible and were heated to 1300 to 1350° C. at a temperature rising rate of about 10° C./min in an electric furnace to be melted. At this time, in order to obtain uniformity and homogeneity of glass, the molten product was held for 2 hours while being stirred. Thereafter, the platinum crucible was taken out of the electric furnace, and the molten product in the crucible was poured into a carbon casting jig previously heated to about 250° C. to manufacture two glass blocks each having a size of about 20×20×60 mm.

Transparency of the manufactured glass blocks was visually confirmed. A case where a uniform and homogeneous glass state was obtained was evaluated as “o” (passed), and a case where a part was crystallized (cloudy) or phase separation occurred was evaluated as “x” (not passed). A good glass manufacturing property makes it possible to obtain good thermal moldability and neutron-absorbing materials having various shapes and sizes as illustrated in FIGS. 1A to 1D. Table 4 below indicates evaluation results of a glass manufacturing property in Examples (glass Nos. GA-01 to GA-30). Table 5 below indicates evaluation results of a glass manufacturing property in Comparative Examples (glass Nos. GB-01 to GB-44).

(2) Evaluation of Characteristic Temperature (Measurement of Transition Point T_{g})

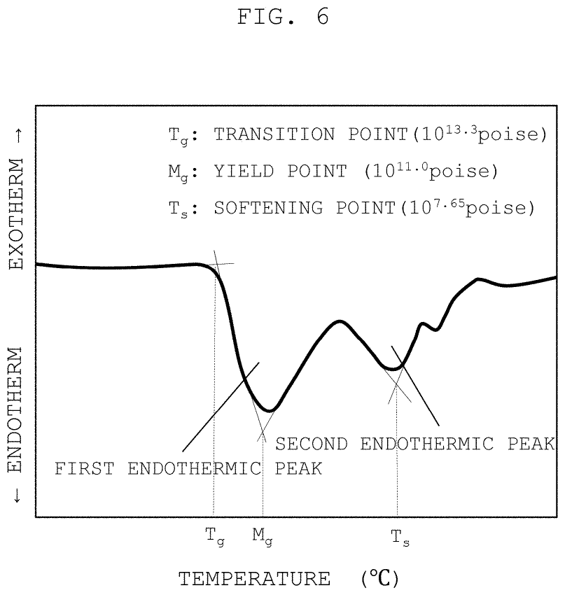

The glass manufactured as described above was made into powder, and a transition point T_{g} as a characteristic temperature specific to glass was measured by differential thermal analysis (DTA). FIG. 6 is a representative curve obtained by DTA measurement of a glass composition. An initiation temperature of a first endothermic peak is the transition point T_{g}, and is defined as a temperature at which the viscosity is equivalent to 10^{13.3} poises. This characteristic temperature is necessary for determining a heat treatment temperature of a manufactured glass block. When a manufactured glass block is machined, the glass block is heated for about 1 to 2 hours at a temperature 10 to 20° C. higher than the T_{g}, is gradually cooled, and a thermal strain is thereby removed. If a thermal strain remains in the glass block, a break or a crack is easily generated, and it is difficult to machine the glass block into a desired shape. Table 4 below indicates evaluation results of a characteristic temperature (transition point T_{g}) in Examples (glass Nos. GA-01 to GA-30). Table 5 below indicates evaluation results of a characteristic temperature (transition point T_{g}) in Comparative Examples (glass Nos. GB-01 to GB-44). Note that, in Comparative Examples, a characteristic temperature (transition point T_{g}) was not evaluated for a sample which was not in a uniform and homogeneous glass state.

(3) Evaluation of Water Resistance

Water resistance of a glass composition was evaluated by weight loss (mg/cm²) obtained by immersing a mirror-finished 10×10×10 mm (cubic) glass test piece in seawater diluted in 200 times at 80° C. for 240 hours. A case where the weight loss was less than 10 mg/cm was evaluated as “o” (passed), and a case where the weight loss was 10 mg/cm² or more was evaluated as “x” (not passed). Particularly, a case where such excellent water resistance that the weight loss was less than 1 mg/cm² was exhibited was evaluated as “⊙” (excellent). Table 4 below indicates evaluation results of water resistance in Examples (Glass Nos. GA-01 to GA-30). Table 5 below indicates evaluation results of water resistance in Comparative Examples (glass Nos. GB-01 to GB-44). Note that, in Comparative Examples, water resistance was not evaluated for a sample which was not in a uniform and homogeneous glass state.

(4) Evaluation of Irradiation Resistance

Irradiation resistance of a glass composition was evaluated based on the degree of discoloration of a mirror-finished 15×15×10 mm glass test piece after the test piece was irradiated with γ rays. As γ ray irradiation conditions, a γ ray dose rate was 1 kGy/hour and irradiation time was 240 hours. A case where the color and transparency of a glass test piece hardly changed was judged as “⊙” (passed), a case where the color and transparency slightly changed was judged as “o” (almost passed), and a case where the color and transparency obviously changed and structural collapse was recognized was judged as “x” (not passed). Table 4 below indicates evaluation results of irradiation resistance in Examples (Glass Nos. GA-01 to GA-30). Table 5 below indicates evaluation results of irradiation resistance in Comparative Examples (glass Nos. GB-01 to GB-44). Note that, in Comparative Examples, irradiation resistance was not evaluated for a sample which was not in a uniform and homogeneous glass state.

TABLE 4

| | Glass | | Water resistance | Irradiation resistance |
|---|---|---|---|---|
| | manufacturing | | (weight loss) | (state change) |
| | property | Characteristic | Immersed in seawater | Irradiation with γ-ray |
| | Uniformity | temperature (° C.) | diluted in 200 times at | for 240 hours (γ ray |
| Glass No. | Homogeneity | Transition point T_{g} | 80° C. for 240 hours | dose rate: 1 kGy/h) |
| GA-01 | ◯ | 603 | ⊙ | ◯ |
| GA-02 | ◯ | 597 | ⊙ | ⊙ |
| GA-03 | ◯ | 605 | ⊙ | ⊙ |
| GA-04 | ◯ | 571 | ◯ | ⊙ |
| GA-05 | ◯ | 607 | ⊙ | ◯ |
| GA-06 | ◯ | 594 | ⊙ | ⊙ |
| GA-07 | ◯ | 581 | ◯ | ⊙ |
| GA-08 | ◯ | 572 | ⊙ | ⊙ |
| GA-09 | ◯ | 600 | ⊙ | ⊙ |
| GA-10 | ◯ | 584 | ◯ | ⊙ |
| GA-11 | ◯ | 598 | ⊙ | ⊙ |
| GA-12 | ◯ | 596 | ⊙ | ⊙ |
| GA-13 | ◯ | 572 | ◯ | ⊙ |
| GA-14 | ◯ | 593 | ⊙ | ⊙ |
| GA-15 | ◯ | 601 | ⊙ | ⊙ |
| GA-16 | ◯ | 574 | ◯ | ⊙ |
| GA-17 | ◯ | 594 | ⊙ | ⊙ |
| GA-18 | ◯ | 568 | ◯ | ⊙ |
| GA-19 | ◯ | 598 | ⊙ | ⊙ |
| GA-20 | ◯ | 589 | ◯ | ⊙ |
| GA-21 | ◯ | 605 | ⊙ | ◯ |
| GA-22 | ◯ | 588 | ⊙ | ⊙ |
| GA-23 | ◯ | 578 | ⊙ | ⊙ |
| GA-24 | ◯ | 582 | ⊙ | ◯ |
| GA-25 | ◯ | 597 | ⊙ | ⊙ |
| GA-26 | ◯ | 592 | ◯ | ⊙ |
| GA-27 | ◯ | 580 | ◯ | ⊙ |
| GA-28 | ◯ | 581 | ◯ | ⊙ |
| GA-29 | ◯ | 577 | ◯ | ◯ |
| GA-30 | ◯ | 587 | ◯ | ◯ |

TABLE 5

| | Glass | | Water resistance | Irradiation resistance |
|---|---|---|---|---|
| | manufacturing | | (weight loss) | (state change) |
| | property | Characteristic | Immersed in seawater | Irradiation with γ-ray |
| | Uniformity | temperature (° C.) | diluted in 200 times at | for 240 hours (γ ray |
| Glass No. | Homogeneity | Transition point T_{g} | 80° C. for 240 hours | dose rate: 1 kGy/h) |
| GA-01 | ◯ | 487 | ◯ | X |
| GA-02 | X | — | — | — |
| GA-03 | ◯ | 539 | ◯ | X |
| GA-04 | X | — | — | — |
| GA-05 | X | — | — | — |
| GA-06 | X | — | — | — |
| GA-07 | ◯ | 530 | ◯ | X |
| GA-08 | ◯ | 534 | ◯ | X |
| GA-09 | X | — | — | — |
| GA-10 | X | — | — | — |
| GA-11 | X | — | — | — |
| GA-12 | ◯ | 516 | ◯ | X |
| GA-13 | X | — | — | — |
| GA-14 | X | — | — | — |
| GA-15 | ◯ | 523 | ◯ | X |
| GA-16 | ◯ | 528 | ⊙ | X |
| GA-17 | ◯ | 528 | ⊙ | X |
| GA-18 | ◯ | 616 | ◯ | X |
| GA-19 | X | — | — | — |
| GA-20 | X | — | — | — |
| GA-21 | X | — | — | — |
| GA-22 | X | — | — | — |
| GA-23 | X | — | — | — |
| GA-24 | X | — | — | — |
| GA-25 | ◯ | 587 | ◯ | X |
| GA-26 | ◯ | 588 | ◯ | X |
| GA-27 | X | — | — | — |
| GA-28 | ◯ | 512 | ◯ | X |
| GA-29 | X | — | — | — |
| GA-30 | ◯ | 562 | ◯ | X |
| GA-31 | X | — | — | — |
| GA-32 | X | — | — | — |
| GA-33 | ◯ | 557 | ◯ | X |
| GA-34 | X | — | — | — |
| GA-35 | X | — | — | — |
| GA-36 | X | — | — | — |
| GA-37 | X | — | — | — |
| GA-38 | X | — | — | — |
| GA-39 | X | — | — | — |
| GA-40 | X | — | — | — |
| GA-41 | X | — | — | — |
| GA-42 | X | — | — | — |
| GA-43 | X | — | — | — |
| GA-44 | X | — | — | — |

In Comparative Examples indicated in Table 3, 30 kinds of compositions containing CeO₂ were studied. A most part was not in a uniform and homogeneous glass state due to inclusion of CeO₂, and inclusion of CeO₂ in glass was not easy. No sample achieved inclusion of CeO₂ and uniform and homogeneous vitrification. Meanwhile, in all of GB-01, GB-03, GB-07, GB-08, GB-12, GB-15 to GB-18, GB-25, GB-26, GB-28, GB-30, and GB-33 containing no CeO₇, a uniform and homogeneous glass state was obtained.

In Comparative Examples, water resistance and irradiation resistance were evaluated for a glass composition which was in a uniform and homogeneous glass state. Table 5 indicates that glass compositions of GB-01, GB-03, GB-07, GB-08, GB-12, GB-15 to GB-18, GB-25, GB-26, GB-28, GB-30, and -33 containing no CeO₂ had good water resistance. However, any glass composition was colored (discolored) largely by irradiation with γ rays, and a glass structure collapsed. A cause of the coloration (discoloration) and the structural collapse is that a chemical bond forming a glass structure is cut by irradiation with γ rays.

As described above, it is very difficult to achieve both water resistance and irradiation resistance in a glass composition. As a neutron-absorbing material, a glass composition excellent in both properties has been required.

From the results of the irradiation resistance test, it has been confirmed that Examples GA-01 to GA-30 have excellent neutron-absorbing performance. In spite of inclusion Gd₂O₃ and B₂O at almost the same level as Comparative Examples, all evaluation results of a glass manufacturing property, water resistance, and γ ray irradiation resistance were better than those in Comparative Examples. This is because Bi₂O₃ is contained as a glass component. By inclusion of Bi₂O₃ as a glass component, CeO₂ can be contained as a glass component, and water resistance can also be improved. It is considered that a reason for this is as follows. That is, Bi₂O₃ is easily vitrified with B₂O₃ as a main component, Bi ions have a large polarity within a glass structure, and therefore Ce ions are easily incorporated into the glass structure. Furthermore, a water repellent effect is obtained by the polarity of the Bi ions, and entry of water molecules into the glass structure is prevented. Furthermore, inclusion of Bi₂O₃ makes inclusion of a vitrification stability component such as BaO or SrO and a water resistance improving component such as ZnO, La₂O₃, Y₂O₃, Al₂O_, or ZrO₂ in a glass composition easy. Like Bi₂O₃ (Bi ions), examples of an oxide expected to have such an effect include PbO (Pb ions) and CdO (Cd ions). However, PbO (Pb ions) and CdO (Cd ions) are harmful substances, and therefore inclusion thereof as components of a glass composition is not preferable.

The present invention has found that inclusion of Bi₂O₃ as a glass component in a Gd₂O—B₂O₃ glass composition having high neutron-absorbing performance makes it possible to contain CeO₂ for improving resistance to irradiation with γ rays and neutrons as a glass component and to improve also water resistance.

From results of study on Examples (GA-01 to GA-30), it has been found that as a glass composition, the total content of Gd₂O₃ and B₂O₃ is preferably 65 mol % or more and the total content of Gd₂O₃, B₂O₃, CeO₂, and Bi₂O₃ is preferably 72 to 92 mol %. Furthermore, it has been found that the content of CeO₂ is preferably 1 mol % or more and the content of Bi₂O₃ is preferably 2 mol % or more. Furthermore, it has been found that at least one of BaO, SrO, ZnO, La₂O₃, Y₂O, Al₂O₃, and ZrO₂ is preferably contained.

As preferable composition ranges of components, the content of Gd₂O₃ is 5 to 15 mol %, the content of B₂O₃ is 55 to 75 mol %, the content of CeO₂ is 1 to 10 mol %, the content of Bi₂O₃ is 2 to 15 mol %, and the total content of one or more of BaO, SrO, ZnO, La₂O₃, Y₂O₃, Al₂O₃, and ZrO₂ is 8 to 28 mol %. As particularly effective composition ranges, the content of Gd₂O is 5 to 10 mol %, the content of B₂O₃ is 60 to 70 mol %, the content of CeO₂ is 3 to 10 mol %, the content of Bi₂O₃ is 2 to 10 mol %, and the total content of one or more of BaO, SrO, ZnO, La₂O₃, Y₂O₃, Al₂O₃, and ZrO₂ is 10 to 23 mol %.

### Example 2

In Example 2, glass compositions having various compositions were manufactured in a similar manner to Example 1, and a glass manufacturing property, a characteristic temperature (transition point T_{g}), water resistance, irradiation resistance with respect to radiation (γ rays), and water resistance after irradiation were evaluated. For manufacturing glass, reagents (Gd₂O₃, B₂O₃, CeO₂, Bi₂O₃, BaCO₃, Eu₂O₃, Er₂O₃, Tb₂O₃, Pr₂O₃, and Sm₂O₃) manufactured by Kojundo Chemical Laboratory Co., Ltd. were used as raw materials. Table 6 indicates compositions of manufactured glass compositions and evaluation results thereof. In glasses of GC-2 to 10, a part of Gd₂O₃ was replaced with Pr₂O₃, Sm₂O₃, Eu₂O₃, Tb₂O₃, or Er₂O₃ based on glass of GC-1. An emission state obtained by irradiation with neutrons by the following method was evaluated for a manufactured class. The emission state was evaluated from a peak emission intensity of a mirror-finished 10×10×10 mm (cubic) glass test piece, obtained by irradiating the test piece with neutrons. The peak emission intensity was evaluated by bringing an optical fiber close to the glass sample piece, and taking light into a spectroscope with the optical fiber. As compared with GC-1 as a base, a case where light was clearly emitted was judged as “o”, and a case where light was remarkably emitted was judged as “⊙”.

TABLE 6

| | Composition (mol %) | | | | | | | | | | | | | |
|---|---|---|---|---|---|---|---|---|---|---|---|---|---|---|
| | | | | | | | | | | | | | R₂O | Lanthanide |
| Glass No. | Gd₂O₃ | B₂O₃ | CeO₂ | Bi₂O₃ | BaO | SrO | ZnO | La₂O₃ | Y₂O₃ | Al₂O₃ | ZrO₂ | SiO₂ | (R: Alkali metal) | oxide |
| GC-01 | 8.0 | 70.0 | 4.0 | 4.0 | 8.0 | — | — | 6.0 | — | — | — | — | — | — |
| GC-02 | 6.5 | 70.0 | 4.0 | 4.0 | 8.0 | — | — | 6.0 | — | — | — | — | — | Pr₂O₃: 1.5 |
| GC-03 | 7.9 | 70.0 | 4.0 | 4.0 | 8.0 | — | — | 6.0 | — | — | — | — | — | Sm₂O₃: 0.1 |
| GC-04 | 7.5 | 70.0 | 4.0 | 4.0 | 8.0 | — | — | 6.0 | — | — | — | — | — | Sm₂O₃: 0.5 |
| GC-05 | 7.0 | 70.0 | 4.0 | 4.0 | 8.0 | — | — | 6.0 | — | — | — | — | — | Sm₂O₃: 1.0 |
| GC-06 | 6.0 | 70.0 | 4.0 | 4.0 | 8.0 | — | — | 6.0 | — | — | — | — | — | Sm₂O₃: 2.0 |
| GC-07 | 7.5 | 70.0 | 4.0 | 4.0 | 8.0 | — | — | 6.0 | — | — | — | — | — | Eu₂O₃: 0.5 |
| GC-08 | 7.0 | 70.0 | 4.0 | 4.0 | 8.0 | — | — | 6.0 | — | — | — | — | — | Eu₂O₃: 1.0 |
| GC-09 | 7.5 | 70.0 | 4.0 | 4.0 | 8.0 | — | — | 6.0 | — | — | — | — | — | Tb₂O₃: 0.5 |
| GC-10 | 7.5 | 70.0 | 4.0 | 4.0 | 8.0 | — | — | 6.0 | — | — | — | — | — | Er₂O₃: 0.5 |

| | Glass | | Water resistance | Irradiation resistance | |
|---|---|---|---|---|---|
| | manufacturing | | (weight loss) | (state change) | |
| | property | Characteristic | Immersed in seawater | Irradiation with γ-ray | Emission state by |
| | Uniformity | temperature (° C.) | diluted in 200 times at | for 240 hours (γ ray | irradiation with |
| Glass No. | Homogeneity | Transition point T_{g} | 80° C. for 240 hours | dose rate: 1 kGy/h) | neutrons |
| GC-01 | ◯ | 593 | ⊙ | ⊙ | — |
| GC-02 | ◯ | 582 | ⊙ | ⊙ | ◯ |
| GC-03 | ◯ | 591 | ⊙ | ⊙ | ◯ |
| GC-04 | ◯ | 587 | ⊙ | ⊙ | ⊙ |
| GC-05 | ◯ | 585 | ⊙ | ⊙ | ⊙ |
| GC-06 | ◯ | 578 | ⊙ | ⊙ | ⊙ |
| GC-07 | ◯ | 590 | ⊙ | ⊙ | ◯ |
| GC-08 | ◯ | 588 | ⊙ | ⊙ | ⊙ |
| GC-09 | ◯ | 595 | ⊙ | ⊙ | ◯ |
| GC-10 | ◯ | 597 | ⊙ | ⊙ | ◯ |

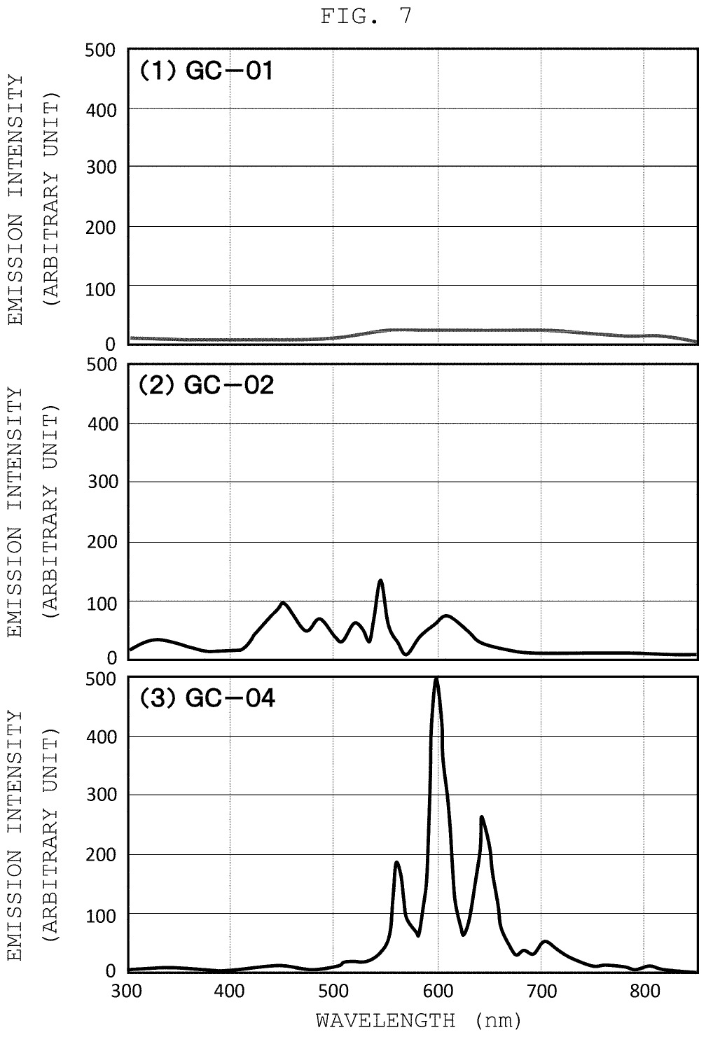

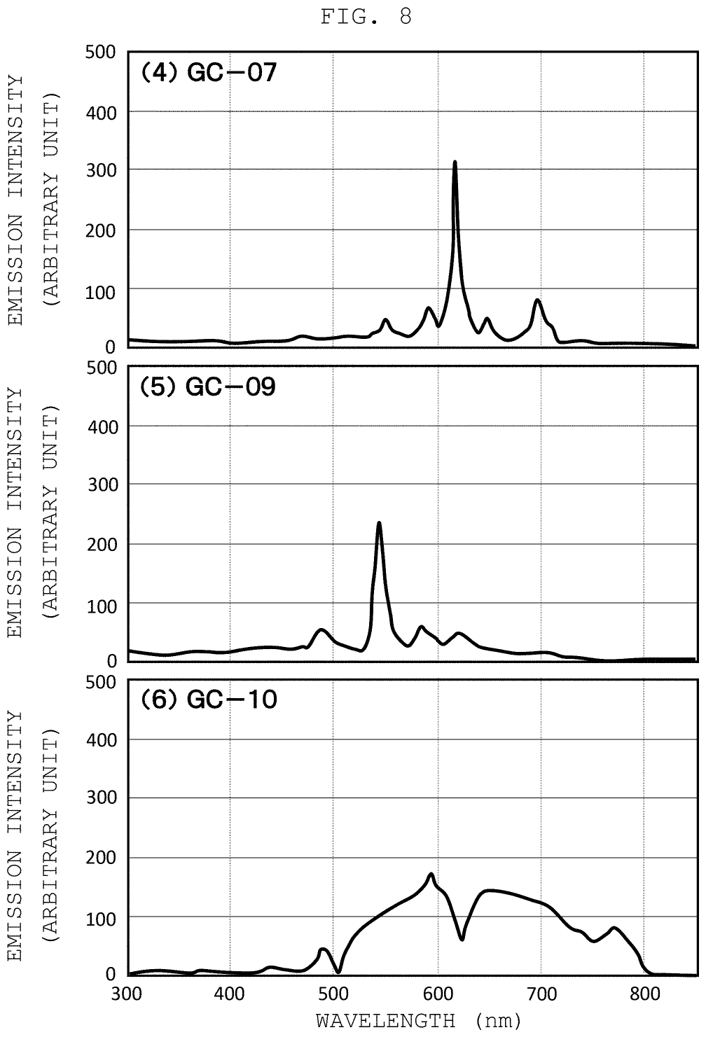

GC-1 indicated in Table 6 was a base glass manufactured by reflecting the result in Example 1, and had very good water resistance and γ ray irradiation resistance. It was recognized that GC-1 had an emission state in which light was slightly emitted due to inclusion of CeO₂ serving also as a light emitting component. Any glass of GC-02 to 10 containing Pr₂O, Sm₂O, Eu₂O₃, Tb₂O₃, or Er₂O₃ had water resistance and γ ray irradiation resistance equivalent to that of GC-01. As compared with GC-01, any one of GC-02 to 10 had an emission state in which light was emitted clearly or remarkably. FIGS. 7 and 8 illustrate representative glass emission spectra. Any glass had a distinctive emission peak due to an emission component, and the intensities of the emission peaks of GC-02, GC-04, GC-07, GC-09, and GC-10 were clear or remarkable as compared with that of GC-01.

Particularly, the peak emission intensity of a glass containing Sm₂O and Eu₂O tended to be large. As indicated in Table 1, it is considered that this is because each of Sm and Eu has a large neutron-absorbing cross section, and therefore is easily excited directly by neutrons and easily emits light. In addition, in order to cause a glass to emit at least light, the glass needs to contain at least 0.1 mol % of at least one of Pr₂O₃, Sm₂O₃, Eu₂O₃, Tb₂O₃, and Er₂O₃, and an emission intensity tended to increase with an increase in the content thereof. However, when the content is more than 2.0 mol %, concentration quenching tends to occur, and on the contrary, an emission intensity tended to decrease. Therefore, the total content of Pr₂O₃, Sm₂O₃, Eu₂O₃, Tb₂O₃, and Er₂O₃ was preferably 0.1 to 2.0 mol %. From the results of the present Example, needless to say, a similar effect can be obtained for inclusion of Nd₂O₃, Dy₂O₃, Ho₂O₃, Tm₂O₃, and Yb₂O₃ which are lanthanide oxides of the same series and can serve as emission components. By use of a glass composition which emits light by irradiation with neutrons as described above as a neutron-absorbing material, it is possible to predict the generation amount of neutrons with the peak emission intensity and a wavelength thereof, and to detect critical proximity.

### Example 3

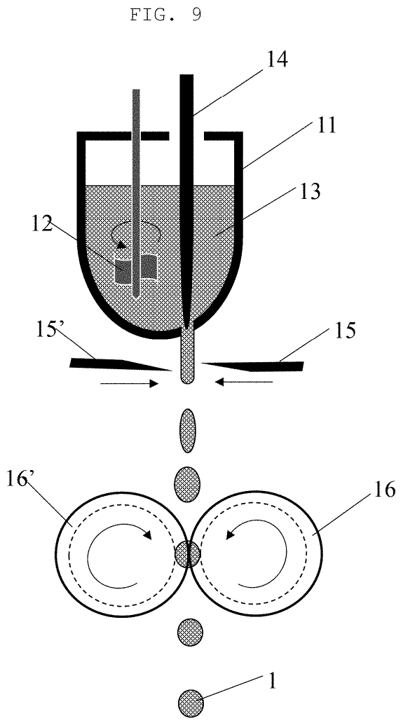

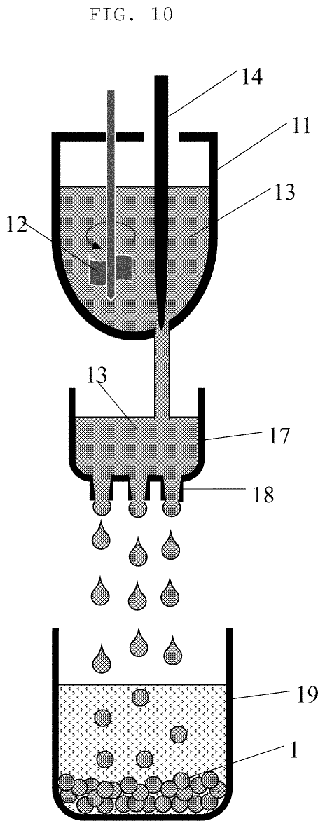

In Example 3, the shape and size of a neutron-absorbing material were studied using the glass compositions according to Example 1. The glass compositions had good thermal moldability, and therefore it was tried to manufacture neutron-absorbing materials having various shapes and sizes. First, the spherical neutron-absorbing material 1 illustrated in FIG. 1A was manufactured. For this neutron-absorbing material 1, the glass composition 2 in Example GA-14 in Table 2 was used. FIG. 9 is a cross-sectional view schematically illustrating an example of a manufacturing apparatus for manufacturing the neutron-absorbing material 1 composed of the glass composition 2. FIG. 10 is a cross-sectional view schematically illustrating another example of a manufacturing apparatus for manufacturing the neutron-absorbing material 1 composed of the glass composition 2. The manufacturing apparatus (equipment) illustrated in FIG. 9 is basically the same as equipment for manufacturing a marble, and is advantageous for manufacturing a relatively large (about 10 mm in diameter) spherical neutron-absorbing material. In addition, the equipment illustrated in FIG. 10 is basically the same as equipment for manufacturing a spherical microlens, and is suitable for manufacturing a relatively small (about 1 to 5 mm in diameter) spherical neutron-absorbing material. An atomization method is effective for manufacturing a finer (about 0.1 to 1 mm in diameter) spherical neutron-absorbing material.

In FIG. 9, the glass composition in Example GA-14 was melted at 1300 to 1350° C. in a glass melting furnace 11, and a molten glass 13 thus obtained was uniformized by rotating a stirring blade 12. Subsequently, by raising a plunger 14 from a lower part to an upper part of the glass melting furnace 11, a predetermined amount of the molten glass 13 was caused to flow out, was sequentially cut by cutters 15 and 15′, and was dropped between rotating molding rolls 16 and 16′. In order to make the molten glass 13 spherical, semicircular grooves are continuously formed on a surface of each of the molding rolls 16 and 16′, and the grooves face each other. The molten glass 13 which had passed between the molding rolls 16 and 16′ was cooled and became the spherical neutron-absorbing material 1. Thereafter, in order to remove a thermal strain of the resulting spherical neutron-absorbing material 1, a heat treatment was performed at a temperature (603 to 613° C. for GA-14) 10 to 20° C. higher than a transition point T_{g}. By removing the thermal strain by the heat treatment, mechanical strength and water resistance of the neutron-absorbing material 1 can be improved.

The average size of the spherical neutron-absorbing material 1 manufactured in FIG. 9 can be controlled to some extent by the amount of the molten glass 13 flowing out of the glass melting furnace 11, cutting speeds of the cutters 15 and 15′, and groove sizes on surfaces of the molding rolls 16 and 16′. In the present Example, the diameter of the neutron-absorbing glass 1 was adjusted so as to be about 10±3 mm.

In FIG. 10, the glass composition in Example GA-14 was melted at 1300 to 1350° C. in the glass melting furnace 11, and the molten glass 13 thus obtained was uniformized by rotating the stirring blade 12. A predetermined amount of the molten glass 13 was poured into a platinum container 17 heated to 1000 to 1100° C. by raising the plunger 14 from a lower part to an upper part of the glass melting furnace 11. A plurality of through nozzles 18 is formed in the platinum container 17. The molten glass 13 was sequentially dropped from the through nozzles 18 to oil 20 in a stainless steel container 19 to obtain the spherical neutron-absorbing material 1 smaller than the glass manufactured with the manufacturing apparatus in FIG. 9. Thereafter, the resulting spherical neutron-absorbing glass 1 was cleaned, and in order to remove a thermal strain, a heat treatment was performed at a temperature (603 to 613° C. for GA-14) 10 to 20° C. higher than a transition point T_{g}. By removing the thermal strain by the heat treatment, mechanical strength and water resistance of the neutron-absorbing material 1 can be improved.

The average size of the spherical neutron-absorbing material 1 manufactured with the manufacturing apparatus illustrated in FIG. 10 can be substantially controlled by a high temperature viscosity of the molten glass 13 in the platinum container 17 and the size (inner diameter and length) of each of the through nozzles 18. In the present Example, the diameter was adjusted so as to be about 1 to 5 mm.

Similarly to the above, the glass composition in Example GA-14 was melted at 1300 to 1350° C., and the nearly spherical fine neutral absorbing material 1 was manufactured by an atomizing method. In the present Example, the diameter of the neutron-absorbing material 1 was adjusted so as to be about 0.1 to 1 mm.

Subsequently, the tablet-shaped neutron-absorbing material 1 illustrated in FIG. 1B was manufactured using the glass composition 2 in Example GA-14. The tablet-shaped neutron-absorbing material 1 was manufactured by manufacturing the spherical glass composition 2 in a similar manner to the above and then crushing the glass composition 2 by hot pressing. Thereafter, a heat treatment (strain removal) was performed in a similar manner to the above, and sieving was further performed to obtain a desired size. The tablet-shaped neutron-absorbing material 1 is less likely to roll than the above spherical neutron-absorbing material, and it is easy to handle the tablet-shaped neutron-absorbing material 1. In addition, a surface area per the same weight is larger than the spherical shape, and therefore improvement in neutron-absorbing performance can be expected.

The granular neutron-absorbing material 1 illustrated in FIG. 1C was manufactured using the glass composition 2 in Example GA-14. First, the glass composition in Example GA-14 was melted and manufactured, and was pulverized to a cullet having an appropriate size with a crusher. This cullet was heated to 800 to 900° C. in a tunnel furnace, and was formed into a granular shape by rolling an edge portion. At this time, a heat treatment (strain removal) was also performed simultaneously in the same tunnel furnace. Thereafter, sieving was performed in a similar manner to the above to obtain a desired size.

The bead-shaped neutron-absorbing material 1 illustrated in FIG. 1D was manufactured using the glass composition 2 in Example GA-14. First, a glass tube having a diameter of about 5 to 8 mm was manufactured using the glass in Example GA-14. The glass tube was scratched at an interval of about 5 mm in length, and was cut by thermal shock. The resulting product was heated to 800 to 900° C. in a tunnel furnace in a similar manner to the above, and was formed into a bead shape by rolling an edge portion. At this time, a heat treatment (strain removal) was also performed simultaneously in the same tunnel furnace. Thereafter, sieving was performed in a similar manner to the above to obtain a desired size. The bead shape can further make a surface area larger than the tablet shape and the granular shape, and therefore further improvement in neutron-absorbing performance can be expected.

### Example 4

In Example 4, the glass compositions according to Example 1 and B₄C particles were composited to manufacture the neutron-absorbing material illustrated in FIG. 2. Powder of the glass composition 2 was mixed with the B₄C particles 3, and the resulting mixture was molded with a die and was heated in a low oxygen atmosphere to manufacture a sintered body of the neutron-absorbing material 1 illustrated in FIG. 2. A reason for heating in a low oxygen atmosphere is to suppress or prevent B₄C oxidation as much as possible. As the glass composition 2, Example GA-09 indicated in Table 2 was used, and was pulverized to 30 μm or less with a stamp mill and a jet mill. Commercial powder of 150 μm or less was used for the B₄C particles 3. 30% by volume of the glass powder in Example GA-09 and 70% by volume of the B₄C powder were blended and mixed, and a plurality of cylindrical molded bodies each having a diameter of 10 mm and a thickness of 5 mm was manufactured using a die under a condition of 1 ton/cm². These molded bodies were cast into a tunnel furnace in a low oxygen atmosphere, and the glass powder in Example GA-09 was softened and was caused to flow at about 900° C. to manufacture a sintered body of the neutron-absorbing material 1. The resulting sintered body had a volumetric shrinkage of about 10%.

Using the neutron-absorbing material 1 of the resulting sintered body, water resistance and resistance to irradiation with γ rays were evaluated in a similar manner to Example 1. As a result, good water resistance and irradiation resistance were obtained. Needless to say, both of the glass composition 2 in Example GA-09 and the B₄C particle 3 have high neutron-absorbing performance, and therefore the sintered body obtained therefrom also has excellent neutron-absorbing performance. Meanwhile, a single substance of B₄C may react gradually with water underwater to form boric acid, and may generate an acidic corrosive environment. By combining B₄C with the glass composition of the present invention, it is possible to reduce a contact area between B₄C and water, and a B element is hardly eluted even by exposure to water for a long period of time because of high water resistance of the glass composition. Furthermore, by compositing B₄C with the glass composition, a sintered body of B₄C can be easily manufactured (sintering temperature can be lowered). Furthermore, by inclusion of the glass composition of the present invention, a density can be larger than use of a single substance of B₄C, and this makes movement by a water flow difficult. Furthermore, this neutron-absorbing material is not limited to applications for injecting the neutron-absorbing material underwater, but can be also developed to a substitute for B₄C particles loaded in a control rod, a substitute for a B₄C sintered body used in a fast reactor, or the like.

In Example 4, compositing the glass compositions according to Example 1 and the B₄C particles has been described. However, particles containing an element having high neutron-absorbing performance indicated in Table 1, such as Gd₂O₃ particles, may be used without being limited to the B₄C particles.

### Example 5

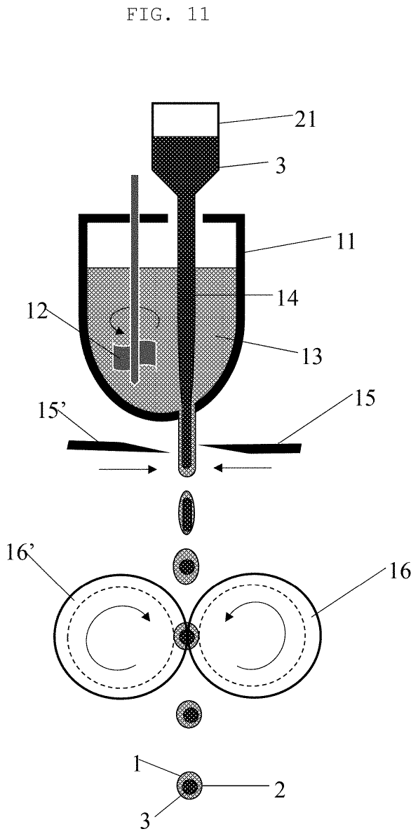

In Example 5, the glass compositions according to Example 1 and B₄C were composited to manufacture the neutron-absorbing material 1 illustrated in FIG. 3. For the neutron-absorbing material 1, the glass composition 2 in Example GA-08 indicated in Table 2 was used. Commercially available granular particles of 1 to 3 mm were used for the B₄C particles 3. FIG. 11 is a cross-sectional view schematically illustrating an example of a manufacturing apparatus for manufacturing a neutron-absorbing material. In the manufacturing apparatus of FIG. 11, the manufacturing apparatus illustrated in FIG. 9 has been improved such that the granular B₄C particles 3 could be injected into the molten glass 13 at 1300 to 1350° C. from the plunger 14. The B₄C particles 3 were housed in a ceramic container 21 above a glass melting furnace 13, and were heated by residual heat of the glass melting furnace 13. In order to prevent oxidation of the B₄C particles 3, an inside of the ceramic container 21 was in an inert atmosphere. The granular B₄C particles 3 were sequentially dropped from the ceramic container 21, and were caused to flow down from a lower portion of the glass melting furnace 11 together with the molten glass 13. In a similar manner to Example 3, the product which had flow down was cut with the cutters 15 and 15′, and was dropped between the molding rolls 16 and 16′ to manufacture the spherical neutron-absorbing material 1 as illustrated in FIG. 3.

In the neutron-absorbing material 1 illustrated in FIG. 3, a surface portion of one B₄C particle 3 is coated with the glass composition 2. However, in the present Example 5, there were many cases where a plurality of B₄C particles was contained. Even with such a form, a big problem does not occur as long as the neutron-absorbing material 1 is coated with the glass composition 2. Thereafter, the resulting neutron-absorbing material 1 was heated at a temperature (582 to 592° C.) 10 to 20° C. higher than the transition point T_{g} of Example GA-08 to remove a thermal strain of the neutron-absorbing material 1.

Using the resulting neutron-absorbing material 1, water resistance and resistance to irradiation with γ rays were evaluated in a similar manner to Example 1. As a result, good water resistance and irradiation resistance were obtained. Needless to say, both of the glass composition 2 in Example GA-08 and the B₄C particle 3 have high neutron-absorbing performance, and therefore the neutron-absorbing material 1 obtained therefrom also has excellent neutron-absorbing performance. Unlike Example 4, the present Example 5 does not need to pulverize a glass composition, to uniformly mix the glass composition with B₄C particles, and to mold and sinter the resulting mixture, and therefore has a characteristic that a neutron-absorbing material consisting of the glass composition and the B₄C particles can be manufactured at low cost. Furthermore, as in Example 4, this neutron-absorbing material is not limited to applications for injecting the neutron-absorbing material underwater, but can be also used as a substitute for B₄C particles loaded in a control rod, a substitute for a B₄C sintered body used in a fast reactor, or the like.

In Example 5, compositing the glass composition of the present invention and the granular B₄C particles has been described. However, granular particles containing an element having high neutron-absorbing performance indicated in Table 1, such as Gd₂O particles, may be used without being limited to the granular B₄C particles.

### Example 6

In Example 6, an example of a method for managing molten fuel to which the neutron-absorbing material according to the present invention as studied in the above Examples 3 to 5 is applied will be described.

In order to maintain subcriticality of molten fuel and enhance safety, a neutron-absorbing material is injected into a nuclear reactor. In FIG. 4, a mass of the molten fuel 4 has sunk underwater 5, and the neutron-absorbing material 1 is injected underwater 5 and is in direct contact with the mass of the molten fuel 4 so as to cover an upper surface of the mass of the molten fuel 4. The density of the neutron-absorbing material 1 is approximately 3 to 5 g/cm³, and is sufficiently larger than that of water or seawater. Therefore, the neutron-absorbing material 1 is easily deposited on a surface of the molten fuel 4. In a case where there is a crack in a mass of the molten fuel 4 or in a case where there is a gap between the masses of the molten fuel 4, the neutron-absorbing material 1 enters these cracks or gaps. As a result, even in a case where a positive reactivity is applied to the molten fuel 4 for some reason, it is possible to prevent criticality from being reached by shielding neutrons generated from the molten fuel 4 and suppressing a chain reaction. The size of the neutron-absorbing material 1 is effectively smaller than that of a mass of the molten fuel 4.

### Example 7

In the present Example 7, an example of a method for taking out molten fuel to which the neutron-absorbing materials manufactured in the above Examples 3 to 5 are applied will be described.

As illustrated in FIG. 5, in operation of taking out the molten fuel 4, the neutron-absorbing material 1 is injected into a nuclear reactor in order to prevent occurrence of re-criticality. FIG. 5 illustrates a state in which the molten fuel 4 is pulverized by the drill 6 of the excavator 8 and the molten fuel 4′ in a particulate form is sucked through the suction pipe 7 of the excavator 8. At this time, a part of the excavated particulate molten fuel 4′ may be scattered underwater 5 therearound without being sucked by the suction pipe 7 of the excavator 8. In this state, a volume fraction of the particulate molten fuel 4′ underwater 5 may change, and re-criticality may occur. Therefore, the neutron-absorbing material 1 is scattered together with the particulate molten fuel 4′ scattered underwater 5 such that neutrons underwater 5 can be absorbed and shielded. This makes it possible to suppress a chain reaction and to prevent re-criticality from being reached even during excavation operation. Even if the neutron-absorbing material 1 is broken during excavation operation, for example, due to being scraped by the drill 6 of the excavator 8, neutron-absorbing performance is not impaired.

In the above description, the method for excavating and digging out molten fuel with a drill has been exemplified, but a digging out device may be a power shovel or the like, and is not limited to the excavator.

### Example 8

In the present Example 8, an example of controlling a nuclear fission reaction of a nuclear reactor by injecting the neutron-absorbing material according to the present invention will be described.

Conventionally, as one method for emergently stopping a nuclear reactor other than use of a control rod, there is a method for injecting boric acid water into a core of a nuclear reactor. However, when boric acid water is added to the core, an inside of the reactor may be in an acidic corrosive environment. In addition, boric acid may be precipitated in cooling piping, and this may clog the piping.

Therefore, in place of injecting boric acid water, the above neutron-absorbing material is injected such that the neutron-absorbing material is deposited around a fuel rod inside the nuclear reactor. As a result, a nuclear fission reaction in the nuclear reactor can be controlled, and the nuclear reactor can be stopped emergently. In a case of using a neutron-absorbing material, it is possible to prevent boric acid from being eluted into water inside the nuclear reactor or to prevent pH from being lowered even if boric acid is eluted. For this reason, it is possible to prevent corrosion of a reactor internal structure and to keep suppressing a reaction of nuclear fuel. Therefore, the nuclear reactor can be stopped for a long period of time.

As described above, according to the present invention, it has been demonstrated that it is possible to provide a glass composition which can be injected underwater, has high neutron-absorbing performance, and hardly causes structural collapse by irradiation with neutrons or γ rays. Furthermore, it has been also demonstrated that it is possible to provide a neutron-absorbing material containing the glass composition, a method for managing molten fuel, a method for taking out molten fuel, and a method for stopping a nuclear reactor.

Note that the present invention is not limited to Examples described above, but includes various modification examples. For example, the above Examples have been described in detail in order to explain the present invention to be understood easily. The present invention does not necessarily include all the components described above. It is possible to replace some components of an Example with components of another Example. It is also possible to add some components of an Example to another Example. In addition, some components of an Example can be deleted or replaced by other components, or another component can be added thereto.

Furthermore, needless to say, the glass composition and the neutron-absorbing material according to the present invention can also be developed as a neutron-shielding material and a nuclear reaction controlling material of a nuclear reactor. For example, in a boiling water type nuclear reactor, a control rod including the glass composition and the neutron-absorbing material of the present invention can be used for controlling a nuclear fission reaction of the nuclear reactor during normal operation and an emergency.

### REFERENCE SIGNS LIST

1 Neutron-absorbing material
2 Glass composition
3 B₄C particles
4, 4′ Molten fuel
5 Underwater
6 Drill
7 Suction pipe
8 Cutting machine
11 Glass melting furnace
12 Stirring blade
13 Molten glass
14 Plunger
15, 15′ Cutter
16, 16′ Molding roll
17 Platinum container
18 Through nozzle
19 Stainless steel container
20 Oil
21 Ceramic container

1. A glass composition comprising Gd₂O₃, B₂O₃, CeO₂, and Bi₂O₃ when components are expressed as oxides, wherein the total content of Gd₂O₃ and B₂O₃ is 65 mol % or more in terms of oxide,
wherein the total content of Gd₂O₃, B₂O₃, CeO₂, and Bi₂O₃ is 72 to 92 mol % in terms of oxide.

2. (canceled)

3. The glass composition according to claim 1, wherein the content of CeO₂ is 1 mol % or more and the content of Bi₂O₃ is 2 mol % or more.

4. The glass composition according to claim 1, further comprising at least one of BaO, SrO, ZnO, La₂O₃, Y₂O₃, Al₂O₃, and ZrO₂.

5. The glass composition according to claim 1, wherein the content of Gd₂O₃ is 5 to 15 mol %, the content of B₂O₃ is 55 to 75 mol %, the content of CeO₂ is 1 to 10 mol %, the content of Bi₂O₃ is 2 to 15 mol %, and the total content of one or more of BaO, SrO, ZnO, La₂O₃, Y₂O₃, Al₂O₃, and ZrO₂ is 8 to 28 mol % in terms of oxide.

6. The glass composition according to claim 1, wherein the content of Gd₂O is 5 to 10 mol %, the content of B₂O₃ is 60 to 70 mol %, the content of CeO₂ is 3 to 10 mol %, the content of Bi₂O₃ is 2 to 10 mol %, and the total content of one or more of BaO, SrO, ZnO, La₂O₃, Y₂O₃, Al₂O₃, and ZrO₂ is 10 to 23 mol %.

7. The glass composition according to claim 1, further comprising at least one of Eu₂O₃, Er₂O₃, Tb₂O₃, Pr₂O₃, Nd₂O₃, Sm₂O₃, Dy₂O, Ho₂O₃, Tm₂O₃, and Yb₂O₃.

8. The glass composition according to claim 7, further comprising at least one of Eu₂O₃, Er₂O₃, Tb₂O₃, Pr₂O₃, Nd₂O₃, Sm₂O₃, Dy₂O₃, Ho₂O₃, Tm₂O₃, and Yb₂O₃ in an amount of 0.1 to 2.0 mol % in total in terms of oxide.

9. A neutron-absorbing material comprising the glass composition according to claim 1.

10. The neutron-absorbing material according to claim 9, further comprising B₄C particles.

11. The neutron-absorbing material according to claim 10, wherein the B₄C particles are granular and surfaces of the B₄C particles are coated with the glass composition.

12. The neutron-absorbing material according to claim 9, wherein the shape is a spherical shape, a tablet shape, a granular shape, or a bead shape.

13. The neutron-absorbing material according to claim 9, having an average size of 0.1 mm mesh or more and less than 15 mm mesh.

14. A neutron-absorbing material comprising: a first glass composition having an average size of 0.1 mm mesh or more and less than 5 mm mesh; and a second glass composition having an average size of 5 mm mesh or more and less than 15 mm mesh, wherein
each of the first glass composition and the second glass composition is the glass composition according to claim 1.

15. A method for managing molten fuel, wherein the neutron-absorbing material according to claim 9 is injected toward molten fuel in a nuclear reactor pressure vessel or a containment vessel disposed underwater, and the neutron-absorbing material is brought into contact with the molten fuel.

16. A method for taking out molten fuel, wherein the neutron-absorbing material according to claim 9 is injected toward molten fuel in a nuclear reactor pressure vessel or a containment vessel disposed underwater, the neutron-absorbing material is brought into contact with the molten fuel, and the molten fuel is pulverized and taken out of the nuclear reactor pressure vessel or the containment vessel.

17. The method for taking out molten fuel according to claim 16, wherein the molten fuel is taken out of the nuclear reactor pressure vessel or the containment vessel by pulverizing and sucking the molten fuel.

18. A method for stopping a nuclear reactor, wherein the neutron-absorbing material according to claim 9 is injected into the nuclear reactor, and the neutron-absorbing material is deposited around a fuel rod inside the nuclear reactor.
